(19) United States
(12) Patent Application Publication
(10) Pub. No.: US 2018/0206038 A1
(43) Pub. Date: Jul. 19, 2018

(54) REAL-TIME PROCESSING OF AUDIO DATA CAPTURED USING A MICROPHONE ARRAY

(71) Applicant: Bose Corporation, Framingham, MA (US)

(72) Inventors: Daniel Ross Tengelsen, Framingham, MA (US); Austin Mackey, Brighton, MA (US); Wontak Kim, Cambridge, MA (US)

(21) Appl. No.: 15/406,298

(22) Filed: Jan. 13, 2017

(51) Int. Cl. H04R 5/027; H04R 3/00; H04S 7/00

(52) U.S. Cl. CPC H04R 5/027; H04R 3/005; H04S 2400/15; H04R 2430/23; H04S 2420/01; H04S 7/304

(57) ABSTRACT

The technology described in this document can be embodied in a method of reproducing audio related to a teleconference between a second location and a remote first location. The method includes receiving data representing audio captured by a microphone array disposed at the remote first location. The data includes directional information representing the direction of a sound source relative to the remote microphone array. The method also includes obtaining, based on the directional information, information representative of head-related transfer functions (HRTFs) corresponding to the direction of the sound source relative to the remote microphone array, and generating, using one or more processing devices, an output signal for an acoustic transducer located at the second location. The output signal is generated by processing the received data using the information representative of the one or more HRTFs, and is configured to cause the acoustic transducer to generate an audible acoustic signal.

### TECHNICAL FIELD

This disclosure generally relates to acoustic devices that include microphone arrays for capturing acoustic signals.

### BACKGROUND

An array of microphones can be used for capturing acoustic signals along a particular direction.

### SUMMARY

In general, in one aspect, this document features a method of reproducing audio related to a teleconference between a second location and a remote first location. The method includes receiving data representing audio captured by a microphone array disposed at the remote first location, wherein the data includes directional information representing the direction of a sound source relative to the remote microphone array. The method also includes obtaining, based on the directional information, information representative of one or more head-related transfer functions (HRTFs) corresponding to the direction of the sound source relative to the remote microphone array, and generating, using one or more processing devices, an output signal for an acoustic transducer located at the second location. The output signal is generated by processing the received data using the information representative of the one or more HRTFs, and is configured to cause the acoustic transducer to generate an audible acoustic signal.

In another aspect, this document features a system that includes an audio reproduction engine having one or more processing devices. The audio reproduction engine is configured to receive data representing audio captured by a microphone array disposed at the remote location, wherein the data includes directional information representing the direction of a sound source relative to the remote microphone array. The audio reproduction engine is also configured to obtain, based on the directional information, information representative of one or more head-related transfer functions (HRTFs) corresponding to the direction of the sound source relative to the remote microphone array, and generate an output signal for an acoustic transducer by processing the received data using the information representative of the one or more HRTFs. The output signal is configured to cause the acoustic transducer to generate an audible acoustic signal.

In another aspect, this document features one or more machine-readable storage devices having encoded thereon computer readable instructions for causing one or more processing devices to perform various operations. The operations include receiving data representing audio captured by a microphone array disposed at the remote first location, wherein the data includes directional information representing the direction of a sound source relative to the remote microphone array. The operations also include obtaining, based on the directional information, information representative of one or more head-related transfer functions (HRTFs) corresponding to the direction of the sound source relative to the remote microphone array, and generating, using one or more processing devices, an output signal for an acoustic transducer located at the second location. The output signal is generated by processing the received data using the information representative of the one or more HRTFs, and is configured to cause the acoustic transducer to generate an audible acoustic signal.

Implementations of the above aspects may include one or more of the following features. The directional information can include one or more of an azimuth angle, an elevation angle, and a distance of the sound source from the remote microphone array. Individual microphones of the microphone array can be disposed on a substantially cylindrical or spherical surface. The information representative of the one or more HRTFs can be obtained by accessing a database of pre-computed HRTFs stored on a non-transitory computer-readable storage device. Obtaining the information representative of the one or more HRTFs includes determining, based on the directional information, that a corresponding HRTF is unavailable in the database of pre-computed HRTFs, and computing the corresponding HRTF based on interpolating one or more HRTFs available in the database of pre-computed HRTFs. One or more directional beam-patterns can be employed to capture the audio by the microphone array. When multiple directional beam patterns used to capture the audio, generating the output signal for the acoustic transducer can include multiplying the multiple directional beam patterns with corresponding weights to generate weighted beam-patterns, and generating the output signal by processing the weighted beam-patterns using the information representative of the one or more HRTFs. The output signal for the acoustic transducer can represent a convolution of at least a portion of the received information with corresponding impulse responses of the one or more HRTFs. The acoustic transducer can be disposed in one of: an in-ear earphone, over-the-ear earphone, or an around-the-ear earphone. Obtaining information representative of the one or more HRTFs can include receiving information representing an orientation of the head of a user, and selecting the one or more HRTFs based on the information representing the orientation of the head of the user.

Various implementations described herein may provide one or more of the following advantages. By processing received audio data based on directional information included within it, a user's perception of the generated audio can be configured to be coming from a particular direction. When used in teleconference or video conference applications, this may improve user experience by providing a realistic impression of sound coming from a source at a virtual location that mimics the location of the original sound source with respect to the audio capture device. In addition, directional sensitivity patterns (or beams) generated via beamforming processes may be weighted to emphasize and/or deemphasize sounds from particular directions. This in turn may allow for improving focus on one or more speakers during a teleconference. The orientation of the head of a user at the destination location may be determined, for example using head-tracking, and the received information can be processed adaptively to move the location of a virtual sound source in accordance with the head-movements.

Two or more of the features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 is an example of a teleconference/video-conference environment.

FIG. 2 is a schematic diagram of a teleconference system in accordance with the technology described herein.

FIG. 3 is a schematic diagram illustrating head-related transfer functions.

FIG. 4 is a flowchart of an example process for generating an output signal for an acoustic transducer in accordance with the technology described herein.

### DETAILED DESCRIPTION

This document describes technology for processing audio data transmitted from an origin location to a destination location. The audio data at the origin location can be captured using a microphone array or other directional audio capture equipment, and therefore include directional information representing a relative location of a sound source with respect to the audio capture equipment. The audio data received at the destination location can be processed based on the directional information in a way such that a user exposed to the resultant acoustic signals perceives the signals to be coming from a virtual location that mimics the relative location of the original sound source with respect to the audio capture equipment at the origin location. In some cases, this can result in a superior teleconference experience that allows a participant to identify the direction of a sound source based on binaurally played audio. For example, if a participant at the destination location knows the relative locations of multiple users participating in the teleconference at the origin location, the participant may readily distinguish between the users based on the virtual direction from which the binaurally played audio appears to be coming. This in turn may reduce the need of speakers identifying themselves during the teleconference and result in an improved and more natural teleconference experience.

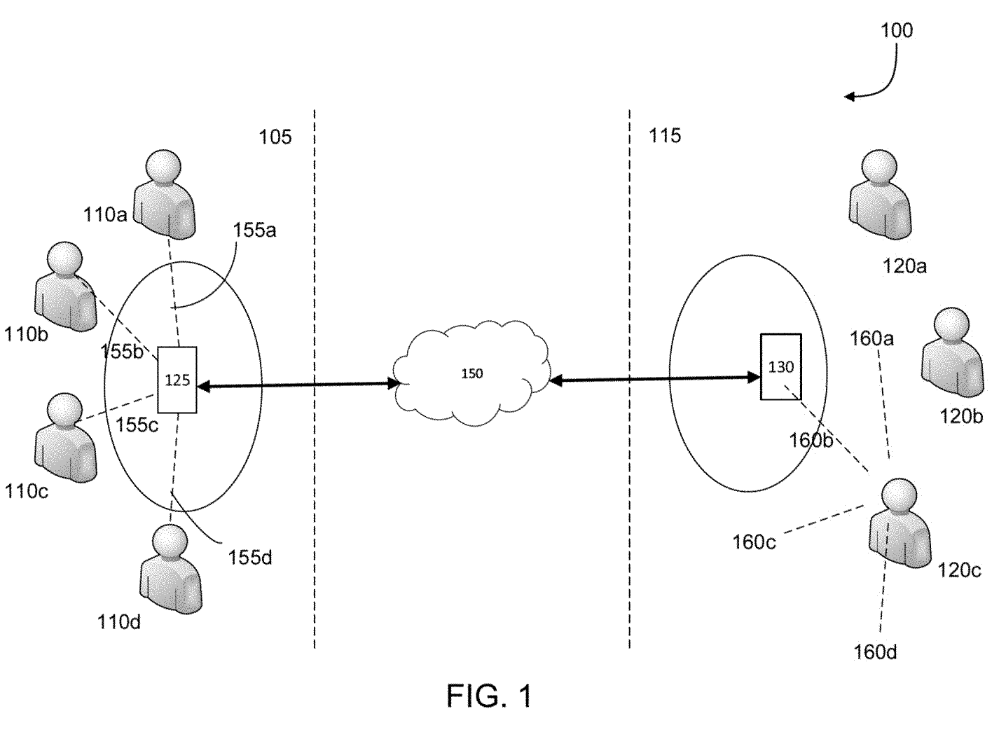

FIG. 1 shows an example environment 100 for a teleconference between two locations. In this example, the first location 105 includes four participants 110a-100d (110, in general), and the second location 115 includes three participants 120a-120c (120, in general) participating in a teleconference. The teleconference is facilitated by communication devices 125 and 130 located at the first and second locations, respectively. The communication devices 125 and 130 can include telephones, conference phones, mobile devices, laptop computers, personal acoustic devices, or other audio/visual equipment that are capable of communicating with a remote device over a network 150. The network 150 can include, for example, a telephone network, a local area network (LAN), a wide area network (WAN), the Internet, a combination of networks, etc.

In some cases, when multiple participants are taking part in a teleconference, it may be challenging to discern who is speaking at a given time. For example, in the example of FIG. 1, when teleconference audio originating at the first location 105 is reproduced via an acoustic transducer (e.g., a speaker, headphone or earphone) at the second location 115, a participant 120 may not readily be able to identify who among the four participants 110a-110d is speaking. In instances where one or more of the remote participants 110 are not personally known to a participant 120 at the second location 115, the participant 120 may not be able to identify the speaker by the speaker's voice. This may be exacerbated in situations when multiple speakers are speaking simultaneously. One way to resolve the ambiguity could be for the speakers to identify themselves before speaking. However, in many practical situations that may be disruptive and/or even unfeasible.

In some implementations, the technology described herein can be used to address the above-described ambiguity by processing the audio signals at the destination location prior to reproduction such that the audio appears to come from the direction of the speaker relative to the audio capture device used at the remote location. For example, if the device 125 is used as an audio capture device at the first location 105, and the speaker 110d is speaking, the corresponding audio that is reproduced at the second location 115 for a listener (e.g., participant 120c) can be processed such that the reproduced audio appears to come from a direction that mimics the direction of the speaker with respect to the audio capture device at the first location 105. In this particular example where participant 110d is speaking at the first location 105, the processed audio reproduction for participant 120c at the second location 115 can cause the participant 120c to perceive the audio as coming from the direction 160d, which mimics or represents the direction 155d of the speaker 110d relative to the audio capture device 125. Therefore, when the participants 110a, 110b, 110c, or 110d speak at the first location 105, the audio is reproduced for the participant 120c as coming from the directions 160a, 160b, 160c, and 160d, respectively. Because the directions 160a-160d mimic the directions 155a-155d, respectively, the participant 120c may be able to then readily discern from the reproduced audio which of the participants 110a-110d is speaking at a given instant. In some cases, this may reduce ambiguity associated with remote speakers, and in turn improve the teleconference experience by increasing naturalness of conversations taking place over a teleconference.

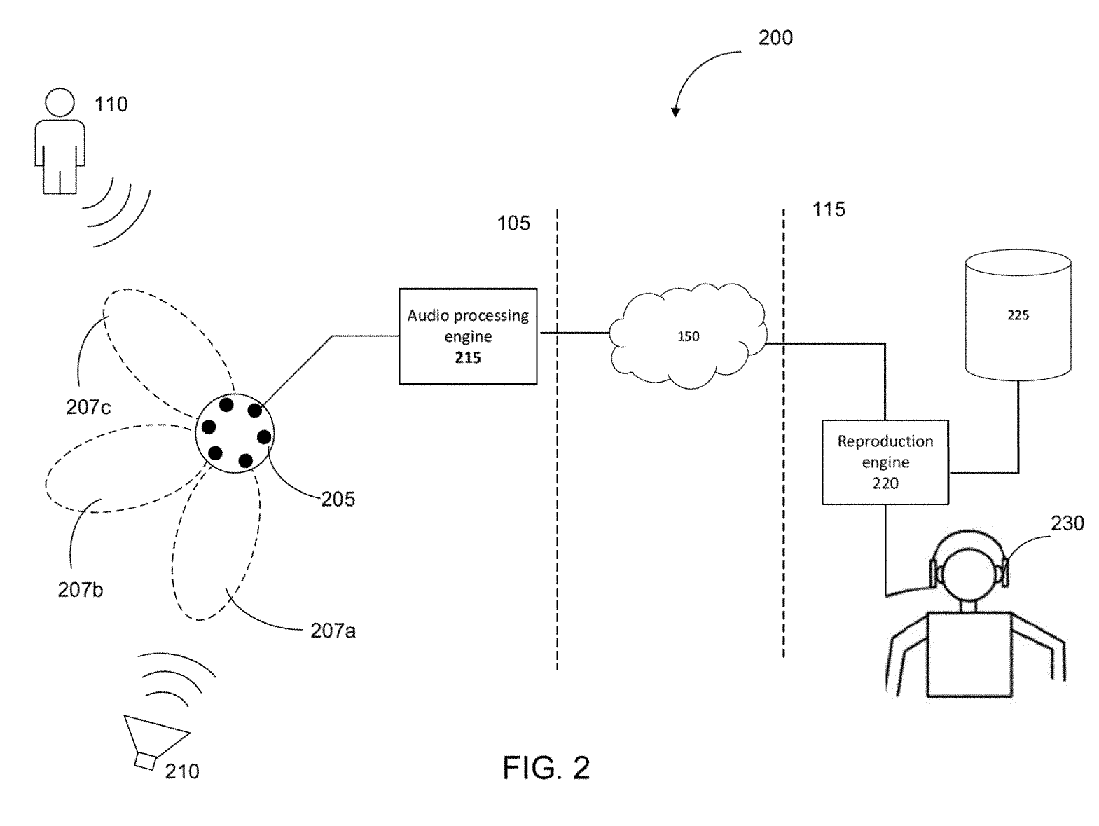

FIG. 2 is a schematic diagram of a system 200 that can be used for implementing directional audio reproduction during a teleconference. The system 200 includes an audio capture device 205 that can be used for capturing acoustic signals along a particular direction. In some implementations, the audio capture device 205 includes an array of multiple microphones that are configured to capture acoustic signals originating at the location 105. For example, the audio capture device 205 can be used for capturing acoustic signals originating from a sound source such as an acoustic transducer 210 or a human participant 110. In some implementations, the audio capture device 205 can be disposed on a device that is configured to generate digital (e.g. binary) data based on the acoustic signals captured or picked up by the audio capture device 205. In some implementations, the audio capture device 205 can include a linear array where consecutive microphones in the array are disposed substantially along a straight line. In some implementations, the audio capture device 205 can include a non-linear array in which microphones are disposed in a substantially circular, oval, or another configuration. In the example shown in FIG. 2 the audio capture device 205 includes an array of six microphones disposed in a circular configuration.

In some implementations, the audio capture device 205 can include other directional audio capture devices. For example, the audio capture device 205 can include multiple directional microphones such as shotgun microphones. In some implementations, the audio capture device 205 can include a device that includes multiple microphones separated by passive directional acoustic elements disposed between the microphones. In some implementations, the passive directional acoustic elements include a pipe or tubular structure having an elongated opening along at least a portion of the length of the pipe, and an acoustically resistive material covering at least a portion of the elongated opening. The acoustically resistive material can include, for example, wire mesh, sintered plastic, or fabric, such that acoustic signals enter the pipe through the acoustically resistive material and propagate along the pipe to one or more microphones. The wire mesh, sintered plastic or fabric includes multiple small openings or holes, through which acoustic signals enter the pipe. The passive directional acoustic elements each therefore act as an array of closely spaced sensors or microphones. Various types and forms of passive directional acoustic elements may be used in the audio capture device 205. Examples of such passive directional acoustic elements are illustrated and described in U.S. Pat. No. 8,351,630, U.S. Pat. No. 8,358,798, and U.S. Pat. No. 8,447,055, the contents of which are incorporated herein by reference. Examples of microphone arrays with passive directional acoustic elements are described in co-pending U.S. application Ser. No. 15/406,045, titled “Capturing Wide-Band Audio Using Microphone Arrays and Passive Directional Acoustic Elements,” the entire content of which is also incorporated herein by reference.

Data generated from the signals captured by the audio capture device 205 may be processed to generate a sensitivity pattern that emphasizes the signals along a “beam” in the particular direction and suppresses signals from one or more other directions. Examples of such beams or sensitivity patterns 207a-207c (207, in general) are depicted in FIG. 2. The beams or sensitivity patterns for the audio capture device 205 can be generated, for example, using an audio processing engine 215. For example, the audio processing engine 215 can include one or more processing devices configured to process data representing audio information captured by the microphone array and generate one or more sensitivity patterns such as the beams 207. In some implementations, this can be done using a beamforming process executed by the audio processing engine 215.

The audio processing engine 215 can be located at various locations. In some implementations, the audio processing engine 215 may be disposed in a device located at the first location 105. In some such cases, the audio processing engine 215 may be disposed as a part of the audio capture device 205. In some implementations, the audio processing engine 215 may be located on a device at a location that is remote with respect to the location 105. For example, the audio processing engine 215 can be located on a remote server, or on a distributed computing system such as a cloud-based system.

In some implementations, the audio processing engine 215 can be configured to process the data generated from the signals captured by the audio capture device 205 and generate audio data that includes directional information representing the direction of a corresponding sound source relative to the audio capture device 205. In some implementations, the audio processing engine 215 can be configured to generate the audio data in substantially real-time (e.g., within a few milliseconds) such that the audio data is usable for real-time or near-real-time applications such as a teleconference. The allowable or acceptable time delay for the real-time processing in a particular application may be governed, for example, by an amount of lag or processing delay that may be tolerated without significantly degrading a corresponding user-experience associated with the particular application. The audio data generated by the audio processing engine 215 can then be transmitted, for example, over the network 150 to a destination location (e.g., the second location 115) of the teleconference environment. In some implementations, the audio data may be stored or recorded at a storage location (e.g., on a non-transitory computer-readable storage device) for future reproduction.

The audio data received at the second location 115 can be processed by a reproduction engine 220 for eventual rendering using one or more acoustic transducer. The reproduction engine 220 can include one or more processing devices that can be configured to process the received data in a way such that acoustic signals generated by the one or more acoustic transducers based on the processed data appear to come from a particular direction. In some implementations, the reproduction engine 220 can be configured to obtain, based on directional information included in the received data, one or more transfer functions that can be used for processing the received data to generate an output signal, which, upon being rendered by one or more acoustic transducers, causes a user to perceive the rendered sound as coming from a particular direction. The one or more transfer functions that may be used for the purpose are referred to as head-related transfer functions (HRTFs), which, in some implementations, may be obtained from a database of pre-computed HRTFs stored at a storage location 225 (e.g., a non-transitory computer-readable storage device) accessible by the reproduction engine 220. The storage location 225 may be physically connected to the reproduction engine 220, or located at a remote location such as on a remote server or cloud drive.

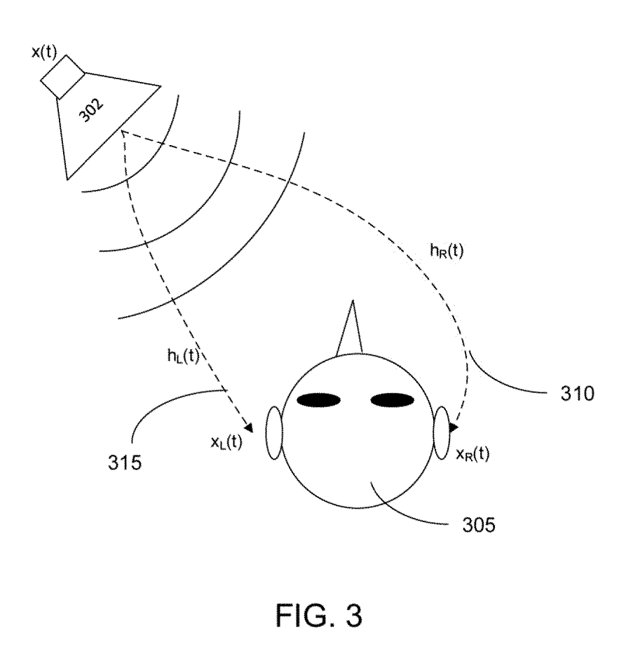

FIG. 3 is a schematic diagram illustrating HRTFs. A head-related transfer function (HRTF) can be used to characterize how an ear receives an acoustic signal originating at a particular point in space, (e.g., as represented by the acoustic transducer 302 in FIG. 3). Each ear can have a corresponding HRTF, and the HRTFs for two ears can be used in combination to synthesize a binaural sound that a user 305 perceives as coming from the particular point in space. Human auditory systems can locate sounds in three dimensions, which may be represented as range (distance), elevation (angle representing a direction above and below the head), and azimuth (angle representing a direction around the head). By comparing differences between individual cues (referred to as monaural cues) received at the two ears, the human auditory system can locate the source of a sound in the three-dimensional world. The differences between the individual or monaural cues may be referred to as binaural cues, which can include, for example, time differences of arrival and/or differences in intensities in the received acoustic signals.

The monaural cues can represent modifications of the original source sound (e.g., by the environment) prior to entering the corresponding ear canal for processing by the auditory system. In some cases, such modifications may encode information representing one or more parameters of the environment, and may be captured via an impulse response representing a path between a location of the source and the ear. The one or more parameters that may be encoded in such an impulse response can include, for example, a location of the source, an acoustic signature of the environment etc. Such an impulse response can be referred to as a head-related impulse response (HRIR), and a frequency domain representation (e.g., Fourier transform) of a HRIR can be referred to as the corresponding head-related transfer function (HRTF). A particular HRIR is associated with a particular point in space around a listener, and therefore, convolution of an arbitrary source sound with the particular HRIR can be used to generate a sound which would have been heard by the listener had it originated at the particular point in space. Therefore, if an HRIR (or HRTF) corresponding to a path between a particular point in space and the user's ear is available, an acoustic signal can be processed by the reproduction engine 220 using the HRIR (or HRTF) to cause the user to perceive the signal as coming from the particular point in space.

FIG. 3 shows a path 310 between the acoustic transducer 302 and the right ear of the user 305, and a path 315 between the acoustic transducer 302 and the left ear of the user 305. The HRIRs for these paths are represented as h_{R}(t) and h_{L}(t), respectively. These impulse responses process an acoustic signal x(t) before the signal is perceived at the right and left ears as x_{R}(t) and x_{L}(t), respectively. Therefore, if the acoustic signals x_{R}(t) and x_{L}(t) are generated by the reproduction engine 220, and played via corresponding acoustic transducers (e.g., right and left speakers, respectively, of a headphone or earphone set worn by the user), the user 305 perceives the sounds as coming from a virtual sound source at the location of the acoustic transducer 302. Therefore, if an appropriate HRIR or HRTF is available, any arbitrary sound can be processed such that it appears to be coming from a corresponding virtual source.

The above concept can be used by the reproduction engine 220 to localize received audio data to virtual sources at particular locations in space. For example, referring to FIG. 2 again, directional information included in the received data can indicate the source of sound to be along the direction represented by the beam 207c (as determined, for example, by the beam 207c capturing more information than the other beams). Based on the directional information, the reproduction engine can be configured to obtain one or more HRIRs or HRTFs that correspond to the same direction as that of the beam 207c relative to the audio capture device 205. This can be done, for example, by the reproduction engine 220 accessing a database of pre-computed HRTFs (or HRIRs) and obtaining the one or more HRTFs or HRIRs associated with the particular direction. The reproduction engine 220 can then compute a convolution of the received time domain data with the corresponding HRIRs (or a product of the frequency domain representation of the received data and the corresponding HRTFs) to generate one or more output signals. The one or more output signals can include separate output signals for the left and right speakers or acoustic transducers of a headphone or earphone set worn by the user. Acoustic signals generated based on the output signals and played back simultaneously using the corresponding acoustic transducers cause the listener to perceive the acoustic signals to be coming from substantially the same direction as that of the beam 207c relative to the audio capture device 205.

The above example assumes the HRTFs or HRIRs to be specific to one particular dimension (azimuth angle) only. However, if HRTFs or HRIRs corresponding to various elevations, distances, and/or azimuths are available, the reproduction engine can be configured to process received audio data to localize a virtual source at various points in space as governed by the granularity of the available HRTFs or HRIRs. In some implementations, an HRTF or HRIR corresponding to the directional information included in the received data may not be available in the database of pre-computed HRTFs or HRIRs. In such cases, the reproduction engine 220 can be configured to compute the required HRTF of HRIR from available pre-computed HRTFs or HRIRs using an interpolation process. In some implementations, if an HRTF or HRIR corresponding exactly to the directional information included in the received data is not available, an approximate HRTF or HRIR (based, for example, on a nearest neighbor criterion) may be used.

In some implementations, the one or more HRTFs can be obtained based on the orientation of the head of the user. For example, if the user moves his/her head, a new or updated HRTF or HRIR may be needed to maintain the location of a virtual sound source with respect to the user. In some implementations, a head tracking process can be employed to track the head of the user, and the information can be provided to the reproduction engine 220 for the reproduction engine to adaptively obtain or compute a new HRTF or HRIR. The head-tracking process may be implemented, for example, by processing data from accelerometers and/or gyroscopes disposed within the user's headphones or earphones, by processing images or videos captured using a camera, or by using other available head-tracking devices and technologies.

In some implementations, the received data can include information corresponding to multiple sensitivity patterns or beams 207a-207c. In some such cases, the reproduction engine 220 can be configured to weight the contribution of the different beams 207 prior to processing the data with the corresponding HRTFs or HRIRs. For example, if a participant 110 is speaking while another sound source (e.g. the acoustic transducer 210, or another participant) is also active, the reproduction engine 220 can be configured to weight the beam 207c higher than other beams (e.g., the beam 207a capturing the signals from the acoustic transducer 210) prior to processing using HRTFs or HRIRs. In some cases, this can suppress interfering sources and/or noise and provide a further improved teleconference experience.

The acoustic transducers used for binaurally playing back acoustic signals generated based on the outputs of the reproduction engine 220 can be disposed in various devices. In some implementations, the acoustic transducers can be disposed in a set of headphones 230 as shown in FIG. 2. The headphones 230 can be in-ear headphones, over-the-ear headphones, around-the-ear headphones, or open headphones. Other personal acoustic devices may also be used. Examples of such personal acoustic devices include earphones, hearing—aids, or other acoustic devices capable of delivering separate acoustic signals to the two ears with sufficient amount of isolation between the two signals, which may be needed for the auditory system to localize a virtual source in space.

The example shown in FIG. 2 illustrates the technology with respect to a one-way communication, in which the first location includes an audio capture device 205 and the second location 115 includes the reproduction engine 220 and the recipient acoustic transducers. Real-world teleconference systems can also include a reverse path, in which the second location 115 includes an audio capture device and the first location 105 includes a reproduction engine.

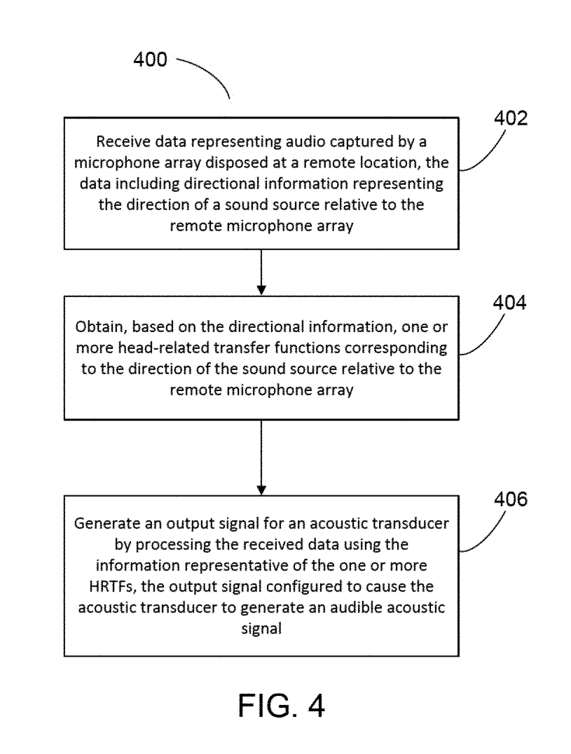

FIG. 4 is a flowchart of an example process 400 for generating an output signal for an acoustic transducer in accordance with the technology described herein. In some implementations, at least a portion of the process 400 can be executed using the reproduction engine 220 described above with reference to FIG. 2. In some implementations, portions of the process 400 may also be performed by a server-based computing device (e.g., a distributed computing system such as a cloud-based system).

Operations of the process includes receiving data representing audio captured by a microphone array disposed at a remote location, the data including directional information representing the direction of a sound source relative to the remote microphone array (402). In some implementations, the microphone array can be disposed in an audio capture device such as the device 205 mentioned above with reference to FIG. 2. For example, individual microphones of the microphone array can be disposed on a substantially cylindrical or spherical surface of the audio capture device. In some implementations, the directional information can include one or more of an azimuth angle, an elevation angle, and a distance of the sound source from the remote microphone array. In some implementations, one or more directional beam-patterns (e.g., the beams 207 described above with reference to FIG. 2) can be employed to capture the audio using the microphone array.

Operations of the process 400 also includes obtaining, based on the directional information, information representative of one or more HRTFs corresponding to the direction of the sound source relative to the remote microphone array (404). The information representative of one or more HRTFs can include information on corresponding HRIRs, as described above with reference to FIG. 3. In some implementations, the information representative of the one or more HRTFs can be obtained by accessing a database of pre-computed HRTFs stored on a non-transitory computer-readable storage device. Obtaining the one or more HRTFs can include determining, based on the directional data, that a corresponding HRTF is unavailable in the database of pre-computed HRTFs, and computing the corresponding HRTF based on interpolating one or more HRTFs available in the database of pre-computed HRTFs. In some implementations, obtaining the one or more HRTFs can include tracking an orientation of the head of a user, and selecting the one or more HRTFs based on the orientation of the head of the user.

Operations of the process 400 further includes generating an output signal for an acoustic transducer by processing the received data using the information representative of the one or more HRTFs, the output signal configured to cause the acoustic transducer to generate an audible acoustic signal (406). This can include generating separating output signals for left channel and right channel audio of a stereo system. For example, the separate output signals can be used for driving acoustic transducers disposed in one of: an in-ear earphone or headphone, an over-the-ear earphone or headphone, or an around-the-ear earphone or headphone. In some implementations, multiple directional beam patterns are used to capture the audio, and generating the output signal for the acoustic transducer includes multiplying the multiple directional beam patterns with corresponding weights to generate weighted beam-patterns, and generating the output signal by processing the weighted beam-patterns using the information representative of the one or more HRTFs. The output signal for the acoustic transducer can represent a convolution of at least a portion of the received information with corresponding impulse responses of the one or more HRTFs.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media or storage device, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit). In some implementations, at least a portion of the functions may also be executed on a floating point or fixed point digital signal processor (DSP) such as the Super Harvard Architecture Single-Chip Computer (SHARC) developed by Analog Devices Inc.

Processing devices suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

Other embodiments and applications not specifically described herein are also within the scope of the following claims. For example, the parallel feedforward compensation may be combined with a tunable digital filter in the feedback path. In some implementations, the feedback path can include a tunable digital filter as well as a parallel compensation scheme to attenuate generated control signal in a specific portion of the frequency range.

Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

1. A method of reproducing audio related to a teleconference between a second location and a remote first location, the method comprising:
receiving data representing audio captured by a microphone array disposed at the remote first location, the data including directional information representing the direction of a sound source relative to the remote microphone array;
obtaining, based on the directional information, information representative of one or more head-related transfer functions (HRTFs), wherein obtaining the information representative of the one or more HRTFs comprises:
receiving information representing an orientation of the head of a user; and
adaptively obtaining the one or more HRTFs based on the information representing the orientation of the head of the user such that the one or more HRTFs are configured to account for the orientation of the head of the user relative to the direction of the sound source with respect to the remote microphone array; and
generating, using one or more processing devices, an output signal for an acoustic transducer located at the second location, the output signal being generated by processing the received data using the information representative of the one or more HRTFs, wherein the output signal is configured to cause the acoustic transducer to generate an audible acoustic signal, such that the audible acoustic signal appears to emanate from the direction of the sound source with respect to the remote microphone array.

2. The method of claim 1, wherein the directional information includes one or more of an azimuth angle, an elevation angle, and a distance of the sound source from the remote microphone array.

3. The method of claim 1, wherein individual microphones of the microphone array are disposed on a substantially cylindrical or spherical surface.

4. The method of claim 1, wherein the information representative of the one or more HRTFs are obtained by accessing a database of pre-computed HRTFs stored on a non-transitory computer-readable storage device.

5. The method of claim 4, wherein obtaining the information representative of the one or more HRTFs comprises:
determining, based on the directional information, that a corresponding HRTF is unavailable in the database of pre-computed HRTFs; and
computing the corresponding HRTF based on interpolating one or more HRTFs available in the database of pre-computed HRTFs.

6. The method of claim 1, wherein one or more directional beam-patterns are employed to capture the audio by the microphone array.

7. The method of claim 1, wherein multiple directional beam patterns used to capture the audio, and generating the output signal for the acoustic transducer comprises:
multiplying the multiple directional beam patterns with corresponding weights to generate weighted beam-patterns; and
generating the output signal by processing the weighted beam-patterns using the information representative of the one or more HRTFs.

8. The method of claim 1, wherein the output signal for the acoustic transducer represents a convolution of at least a portion of the received information with corresponding impulse responses of the one or more HRTFs.

9. The method of claim 1, wherein the acoustic transducer is disposed in one of: an in-ear earphone, over-the-ear earphone, or an around-the-ear earphone.

10. (canceled)

11. A system for reproducing teleconference audio received from a remote location, the system comprising:
an audio reproduction engine comprising one or more processing device, the audio reproduction engine configured to:
receive data representing audio captured by a microphone array disposed at the remote location, the data including directional information representing the direction of a sound source relative to the remote microphone array,
obtain, based on the directional information, information representative of one or more head-related transfer functions (HRTFs) wherein obtaining the information representative of the one or more HRTFs comprises:
receiving information representing an orientation of the head of a user; and
adaptively obtaining the one or more HRTFs based on the information representing the orientation of the head of the user such that the one or more HRTFs are configured to account for the orientation of the head of the user relative to the direction of the sound source with respect to the remote microphone array, and
generate an output signal for an acoustic transducer by processing the received data using the information representative of the one or more HRTFs, wherein the output signal is configured to cause the acoustic transducer to generate an audible acoustic signal, such that the audible acoustic signal appears to emanate from the direction of the sound source with respect to the remote microphone array.

12. The system of claim 11, wherein the directional information includes one or more of an azimuth angle, an elevation angle, and a distance of the sound source from the remote microphone array.

13. The system of claim 11, wherein the audio reproduction engine is configured to obtain the information representative of the one or more HRTFs by accessing a database of pre-computed HRTFs stored on a non-transitory computer-readable storage device.

14. The system of claim 13, wherein the audio reproduction engine is configured to:
determine, based on the directional information, that a corresponding HRTF is unavailable in the database of pre-computed HRTFs; and
compute the corresponding HRTF based on interpolating one or more HRTFs available in the database of pre-computed HRTFs.

15. The system of claim 11, wherein the received data includes information corresponding to multiple directional beam patterns used to capture the audio, and the audio reproduction engine is configured to:
multiply the multiple directional beam patterns with corresponding weights to generate weighted beam-patterns; and
generate the output signal by processing the weighted beam-patterns using the information representative of the one or more HRTFs.

16. The system of claim 11, wherein the output signal for the acoustic transducer represents a convolution of at least a portion of the received information with impulse responses corresponding to the one or more HRTFs.

17. (canceled)

18. One or more machine-readable storage devices having encoded thereon computer readable instructions for causing one or more processing devices to perform operations comprising:
receiving data representing audio captured by a microphone array disposed at a remote first location, the data including directional information representing the direction of a sound source relative to the remote microphone array;
obtaining, based on the directional information, information representative of one or more head-related transfer functions (HRTFs), wherein obtaining the information representative of the one or more HRTFs comprises:
receiving information representing an orientation of the head of a user; and
adaptively obtaining the one or more HRTFs based on the information representing the orientation of the head of the user such that the one or more HRTFs are configured to account for the orientation of the head of the user relative to the direction of the sound source with respect to the remote microphone array; and
generating an output signal for an acoustic transducer located at a second location, the output signal being generated by processing the received data using the information representative of the one or more HRTFs, wherein the output signal is configured to cause the acoustic transducer to generate an audible acoustic signal, such that the audible acoustic signal appears to emanate from the direction of the sound source with respect to the remote microphone array.

19. The one or more machine-readable storage devices of claim 18, wherein the received data includes information corresponding to multiple directional beam patterns used to capture the audio, and generating the output signal for the acoustic transducer comprises:
multiplying the multiple directional beam patterns with corresponding weights to generate weighted beam-patterns; and
generating the output signal by processing the weighted beam-patterns using the information representative of the one or more HRTFs.

20. (canceled)
